(19) United States
(12) Patent Application Publication
(10) Pub. No.: US 2007/0276954 A1
(43) Pub. Date: Nov. 29, 2007

(54) Low-Delay High Quality Video Streaming Using TCP

(75) Inventors: Shueng Han Gary Chan, Hong Kong (CN); Chi Fai Wong, Hong Kong (CN); Jack Chi Fai Tang, Hong Kong (CN); Wai Lam Fung, Hong Kong (CN); Kim Wai Cheuk, Hong Kong (CN)

Correspondence Address: GROOVER & HOLMES, BOX 802889, DALLAS, TX, 75380-2889, US

(73) Assignee: Hong Kong University of Science and Technology, Hong Kong (CN)

(21) Appl. No.: 11/751,198

(22) Filed: May 21, 2007

Related U.S. Application Data
(60) Provisional application No. 60/801,374, filed on May 19, 2006.

(51) Int. Cl. G06F 15/16

(52) U.S. Cl. 709/231

(57) ABSTRACT

A system and method for transmission of video data to a wireless client. In one example embodiment, the present innovations include a proxy server that receives video data from a video server. The proxy includes buffers individually associated to wireless clients. In preferred embodiments, buffers are managed independently so as to optimize video streaming to clients.

### CROSS-REFERENCE TO RELATED APPLICATIONS

This application claims priority from U.S. provisional patent application 60/801,374 filed on May 19, 2006, which is hereby incorporated by reference.

### BACKGROUND AND SUMMARY OF THE INVENTION

The present application relates to streaming video, and more particularly to increasing quality of streaming video across a network.

Description of Background Art

With the penetration and popularity of mobiles devices such as pocket PCs and smart-phones, there is an increasing need for low-delay video streaming over wireless channels. Traditionally, UDP (User Datagram Protocol) is used for video streaming. However, due to unreliable transmission and fluctuating bandwidths of wireless channels, error concealment and recovery mechanisms are needed which greatly increase the complexity and delay of the system. Furthermore, UDP streams often experience more difficulty penetrating firewalls.

Wireless channels are characterized by fluctuation and low bandwidth with unpredictable error. Mobile devices, on the other hand, are characterized by their low processing/computational capability and low memory. Streaming low-delay high-quality video over wireless channel is therefore challenging. Traditionally, User Datagram Protocol (UDP) is used for media streaming. However, UDP is not effective for wireless streaming, mainly due to the following reasons:

Complex error handling mechanism: UDP is an unreliable protocol. As a result, packets may be lost during transit. To offer good-quality video, these losses have to be mitigated. Retransmission, FEC (Forward Error Correction), and error concealment are techniques which may be used. However, efficient retransmission techniques are generally not easy to be implemented. They also increase the complexity at both proxy and client. FEC, and similarity for error resilience coding at the encoder, often increases the delay of the stream and tends to be designed for the worst-case scenario, leading to much bandwidth wastage. Error concealment, on the other hand, is effective for random error rather than burst error characterized by wireless channel. It also increases the complexity at the decoders.

Network unfriendliness: UDP transmission is not elastic and hence not TCP-friendly. As a result, it either takes unfairly too much bandwidth or leads to high packet loss in the presence of fluctuating bandwidth. Though TCP-friendly UDP has been widely discussed their implementation is not straightforward.

Unselective data loss: For video stream, some frames (e.g., those I frames) and some data fields (e.g., those synchronization bits) are more important than others and need to be protected. Since wireless error occurs at any time, these important data may be lost, leading to degradation in quality. If those more important frames or data fields can be selectively protected, better video quality would be achieved.

Firewall penetration: Though some protocols make use of UDP (STUN, SIP, RTP, etc.), many more applications make use of TCP. Applications using UDP more likely experience firewall penetration problem than TCP.

Low-Delay High-Quality Video Streaming Using TCP

In one example embodiment, the present innovations include increasing the quality of streaming video using a proxy server and a wireless client. In preferred embodiments, the proxy server includes buffers dedicated to clients such that each client's buffer can be independently managed by a multi-worker model. The multi-workers model preferably monitors input and output of the buffer, such that when the buffer is full, an algorithm (preferably selective packet drop, or SPD) is used to identify video data (such as video frames or packets) to drop. Other embodiments are described more fully below.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 shows an example system consistent with implementing an example embodiment of the present innovations.

FIG. 2 shows an example embodiment consistent with an example embodiment of the present innovations.

FIG. 3 shows an example Selective Packet Drop algorithm consistent with an embodiment of the present innovations.

FIG. 4 shows video quality under UDP.

FIG. 5 shows video quality under TCP.

FIG. 6 shows PSNR for decoded frames using UDP.

FIG. 7 shows PSNO for decoded frames using TCP.

FIG. 8 shows delay time with respect to the proxy with and without SPD using TCP streaming.

### DETAILED DESCRIPTION OF THE PREFERRED EMBODIMENTS

The numerous innovative teachings of the present application will be described with particular reference to the presently preferred embodiment (by way of example, and not of limitation).

The present innovations include, in an exemplary embodiments, a multi-worker model as implemented at wireless proxy (or elsewhere, such as at the encoder) which handles client requests independently and independently manages individual buffers associated with individual client units. The innovations preferably make use of a technique (selective packet drop) which selectively drops those unimportant frames so as to maintain video quality and low delay in the presence of congestion and fluctuating bandwidth. The model is simple and effective for mobile clients of heterogeneous bandwidth and computing power.

The present innovations preferably include the use of TCP and for low-delay wireless video streaming between a server (preferably a proxy server) and a wireless client. There are several advantages of using TCP:

Reliable transmission: TCP is a reliable protocol, and hence effectively addresses the synchronization and retransmission problem as mentioned above. There is no need of complex error concealment and resilience mechanisms which need to be implemented in the client and proxy. Using TCP, the proxy can be designed to intelligently select and transmit those important frames/data in the presence of fluctuating bandwidth. There is hence more flexibility in choosing which frame to transmit and at what time. No extra framing overhead such as RTP and RTCP is required. One of the advantages of using UDP is its multicast capability. However, given that multicast capability is not pervasive in nowadays wireless networks, using TCP is more natural and simpler choice than UDP.

Network fairness: TCP is intrinsically friendly, which shares network resources with other data traffic/flows in the presence of congestion. There is no need to implement other mechanisms to achieve fairness. It also adapts its transmission rate according to the available network bandwidth, thereof allowing the video applications to make full use of the bandwidth.

Ease of deployment: Using TCP in applications is easy, and TCP applications more readily penetrate firewalls (by means of, for example, http).

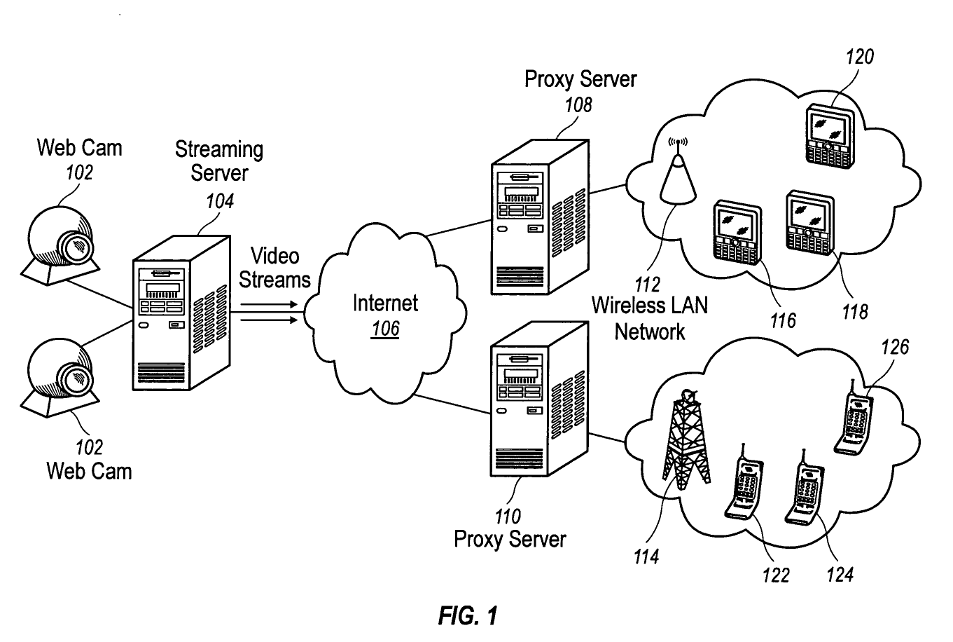

FIG. 1 shows an example architecture for wireless video streaming consistent with implementing an embodiment of the present innovations. In this example, a streaming video server 104 receives video data from, for example, one or more devices such as web cams 102. The streaming video server 104 sends encoded video data across a network (such as the Internet 106, in this example) to one or more proxy servers 108, 110. The proxy servers in turn communicate with, for example, radio access points (such as a wireless LAN access point 112 or cellular network (GPRS) tower 114) which are in communication with one or more wireless clients 116-126.

In a preferred embodiment of the present innovations, the video is first captured and encoded at the streaming server into multiple sub-streams using multiple description coding or layered coding. These sub-streams are then delivered, preferably using either Internet or overlay multicast, to one or more proxies, such as distributed proxies 108, 110. Mobile clients of heterogeneous capability contact these proxies for services. A client of higher bandwidth and/or screen format may get more sub-streams incrementally from its proxy to maximize user's viewing quality.

The wireless network is scalable in the sense that the streaming server does not directly serve all the clients due to hierarchical architecture. By putting more proxies in the network, the system is able to incrementally serve more users. Though algorithms have been proposed and studied to adapt the encoding rate to client's decoding rate, they require receivers to periodically feedback its buffer state to sender. This increases the network bandwidth and the complexity of the server, and raises feedback-implosion issues. Our architecture does not require continuous feedback from the clients, and hence is simple and more scalable.

In an alternative embodiment, the proxies can be located in any location, whether local or remote to the wireless access point. For example, the functionality of the proxy could be implemented in the streaming video server itself, though such implementations are less preferred.

The present innovations, in one example embodiment, focus on the design of proxy in the network in terms of its buffer management to offer low-delay wireless video streaming. By “low delay,” it is meant that there is some target maximum frame delay which should not exceed. This target can be static or dynamic. Note that because all sub-streams may be considered independently, without loss of generality, this description focuses on a single sub-stream, referred to herein as a “stream”.

TCP is appropriate for video streaming from proxy to clients. An issue of using TCP for low-delay streaming is that TCP does not guarantee timely delivery due to retransmission. Because the bandwidth of wireless networks (the 802.11 g LANs versus GPRS network) and client capability (high-end versus low-end phones) may vary widely, we propose and present a multi-worker model which uses flow-based buffer management at proxy. By treating each flow independently, we are able to isolate flows and tailor them for maximum quality, thereof achieving smooth video quality for the clients. The model is simple to implement and is based on our previous scheme of Selective Packet Drop (SPD). SPD meets a certain video delay requirement by allocating a finite-size buffer according to the delay tolerance of each client. The buffer keeps only those current, important and useful frames. However, our current work extends from in the following ways: 1) we use TCP instead of UDP to address wireless error issue; 2) the SPD algorithm is implemented at the proxy rather than in the client. This is done so as to take advantage of the high-end proxies and to reduce the computational and memory requirements at the client. In this way, the computing resources at clients can be dedicated to decode and playback the incoming video packets, hence increasing the video quality.

We have implemented a surveillance system for real-time video streaming based on H.263+. In the system, a desktop PC captures and encodes video to H.263+ format and streams it through a wireless network (wireless LAN for Pocket PCs and GPRS network for smartphones) using TCP. Our performance study and field trials indicate that TCP streaming is effective to provide good-quality video over wireless channel. Using our model, the encoder does not need to encode its stream for each client, greatly reducing system complexity and increasing scalability of the number of clients.

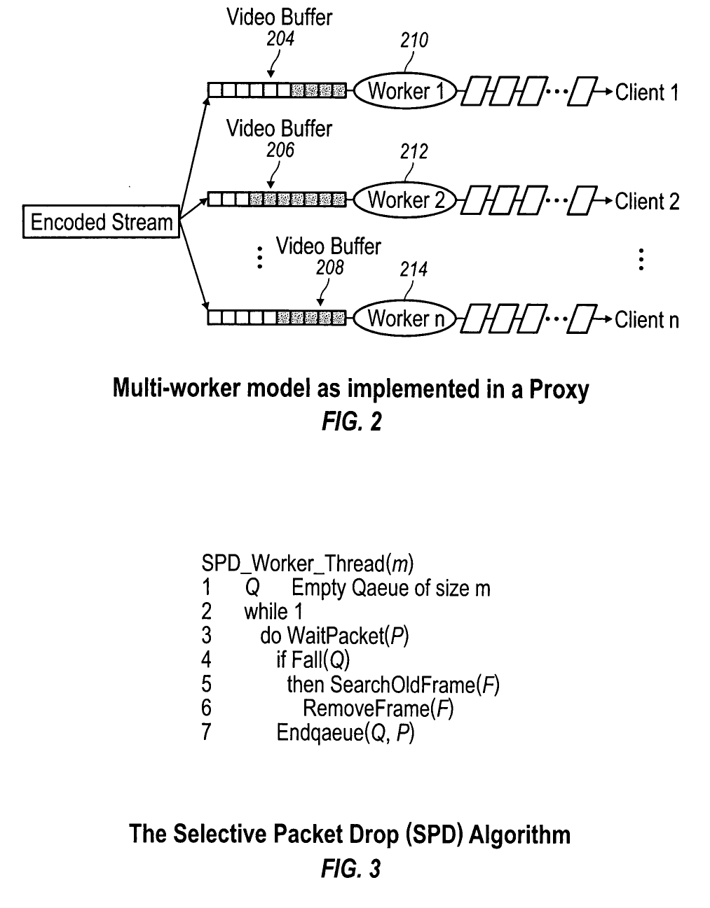

FIG. 2 shows an example of the multi-worker model as implemented in a proxy. In this example, an encoded video stream 202, intended for clients 1, 2, . . . n, is received at a proxy. Proxy includes buffers 204, 206, 208, each of which is dedicated to an individual client. In preferred embodiments, a mobile client is associated with a proxy, which allocates a buffer corresponding to the client's delay requirement. Each of the buffers is managed by a worker 210, 212, 214. The workers are part of a multi-worker model that manages each buffer independently.

A dedicated worker thread is created to serve each client (for example, if clients were added). In other words, each buffer is managed independently using multiple threads. Encoded video frames coming into the proxy is replicated to the video buffer of each client. The frames in the buffer is emptied at the other end to be sent to the client using TCP. The buffer only keeps complete/full frames and may drop some frames in times of overflow (due to congestion).

Due to independent processing of buffers, the bandwidth and processing capability of a client would not affect the other clients in the network. Furthermore, the packet loss of a client would not affect the performance of other clients. In this way, video encoder does not need to adapt its scream on per-flow basis, thereof greatly reducing the complexity of the system.

As TCP is a reliable transport protocol, packets are retransmitted upon lost. Hence, all the frames emptied from the buffer would eventually arrive at the client. As frames are put into the buffer and be consumed at the other end with different rates, frames, and hence streaming delay, may accumulate at the buffer. When the buffer becomes full, those not-so-important frames need to be dropped to meet low-delay requirement.

When the buffer starts to overflow, we have used the technique of Selective Packet Drop (SPD) to maintain low delay and high video quality. SPD is implemented at the proxy so as to relieve the computation at the client. A client simply decodes the arrived frames and does not need to keep track of the delay problem.

SPD Worker Thread(m)
1 Q +− Empty Queue of size m
2 while 1
3 do WaitPacket(P )
4 if Full(Q)
5 then SearchOldFrame(F )
6 RemoveFrame(F )
7 Enqueue(Q, P )

To achieve high quality low-delay video, SPD makes use of the observation that the importance of video frames in a GoP (Group of Picture) of IPPP . . . sequence decreases from the first I to the last P. This is because each P frame in the GoP uses the previous frame as reference. When a P frame is lost due to buffer overflow, all the subsequent P frames would not be useful and may be as well dropped. Other schemes for selectively dropping packets and/or filling the buffers can also be implemented.

FIG. 3 shows an example of the algorithm each dedicated worker thread runs for a buffer. In this example, it is the SPD (selective packet drop) algorithm. In SPD, packets are allowed to accumulate in the buffer as long as there is space. SPD algorithm preferably keeps the most recent I-frames and its following P-frames. This queuing discipline achieves high performance by making use of the limited buffer—it keeps only those useful and recent frames in the buffer whenever possible. At the arrival of a frame, the worker takes the following actions (in preferred embodiments):
1. If the buffer is not full, enqueue the frame;
2. Otherwise, drop the least useful frame, which is
   the last P-frame in the leading GoP at the head of the queue, provided that it is not at the tail of the queue;
   if the P-frame is at the tail of queue and if the incoming frame is P, drop the incoming frame and all its subsequent P-frames; otherwise (i.e., the incoming is an I-frame), drop the P-frame at the tail;
   if the GoP at the head of the queue contains no P-frame (i.e., the head of queue is I 1 . . . ), drop the I-frame at the head of the queue.

In SPD, frames are hence dropped to keep those most important and current ones in the buffer. This is done to keep the buffer in good utilization with useful frames. SPD always puts into the buffer the most recent I-frame and the P-frame whose reference frame has not been dropped. Clearly, the size of the buffer indicates the maximum delay of the stream.

Detailed Example

An example of the current innovations have been implemented as shown in FIG. 1. In this section, we first present the experimental environment followed by measurement results. It is noted that the following examples are only intended to be exemplary, and do not limit application or embodiments of the present innovations. Other implementations are possible.

The Foreman QCIF sequence is used as a representative video sequence in our experiment. The sequence consists of 400 frames. The frames are encoded in H.263+ format before delivered over the Internet.

The server-side video delivery program run on a Pentium IV 3 GHz PC with 1 GB memory. The server is connected to a 100 Mbps LAN. The mobile access point offering wireless network connections is directly connected to the same LAN. The GPRS service was offered by China Resources Peoples Telephone Company Limited. One of the client-side program runs on a HP iPAD h5450 Pocket PC. Besides the wireless LAN card, no other additional hardware was installed to the Pocket PC. Another client-side program on an i-mateTM SP3 SmartPhone with external storage card.

Regarding H.263+ encoder settings, we use a Quantization Parameter (QP) of 13, a search window size of 15, a GOP size of 4, and without error concealment. The encoded video stream is transmitted packet-by-packet to the clients. Each encoded frame is divided into fixed-size packets of 2,048 bytes. The buffer of each worker is a FIFO queue accommodating up to 10 frames.

We stream the video using TCP and UDP, and compare the video quality in terms of subjective visual inspection and objective PSNR metric. We also examine the frames that are lost, and the delay incurred with or without the video buffer. We simulate the error environment by randomly dropping video frames at the exit of the proxy. We present the case of high error environment where we randomly drop 15% of frames. For TCP, this means that some frames are sent multiple times before the next one is transmitted. Besides the drop, the wireless networks are observed to have much lower loss rate during our measurement and hence may be ignored.

Measurement Results

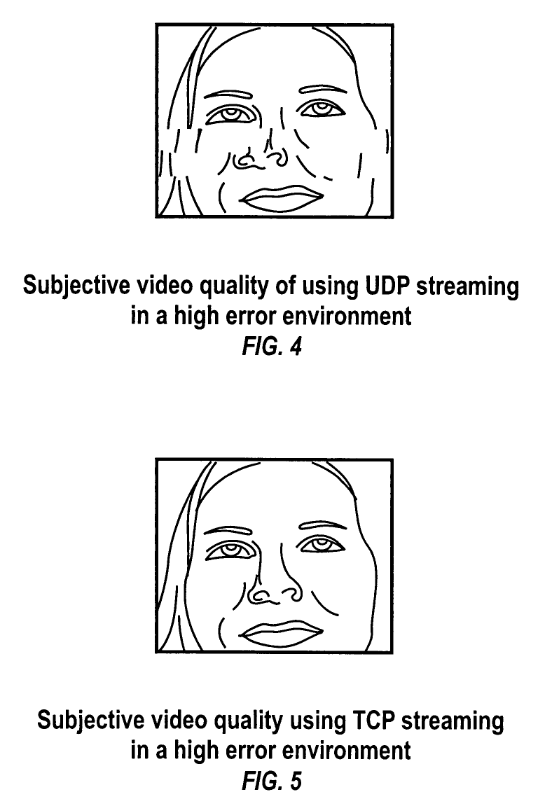

In FIGS. 4 and 5 we show the subjective video quality for UDP and TCP streaming, respectively. Clearly, the one with TCP is better. For UDP in a high error environment, due to its unreliable and unselective data loss, the video quality is poor and may lead to loss of synchronization. This is not case for TCP.

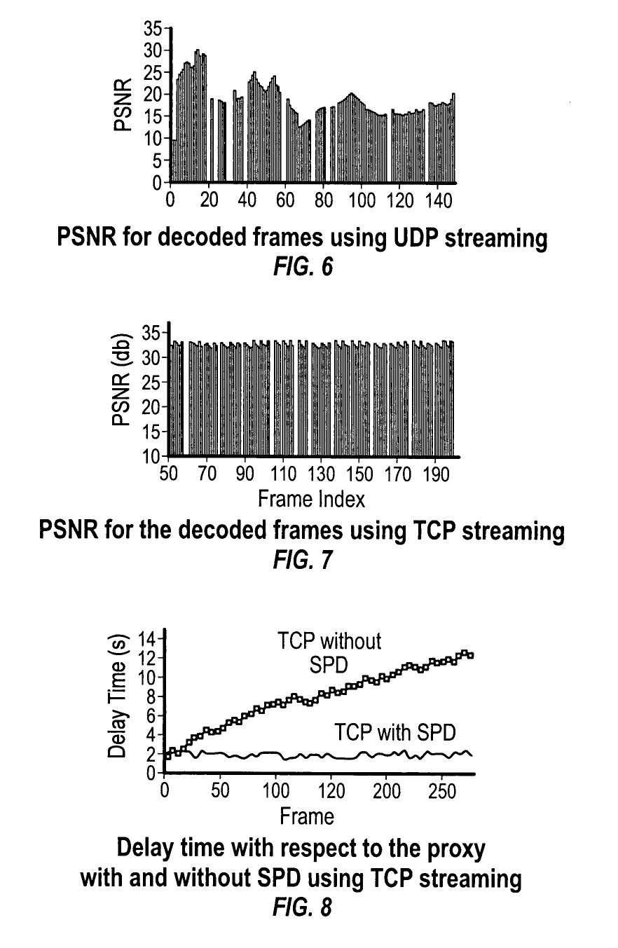

FIG. 6 shows PSNR for the decoded frames using UDP streaming. The gaps in the sequence mean dropped or missed frames. This due to loss of synchronization and unrecoverable errors. It is clear that the video quality decreases sharply upon a frame loss. The errors propagate to subsequent frames (due to inter-coded P frames to reduce temporal redundancy), leading to substantial reduction in video quality and gaps. In this environment, much of the channel bandwidth is wasted to transmit poor-quality or useless frames. The resultant video quality is also not smooth.

FIG. 7 shows the PSNR for decoded frames using our TCP streaming. The PSNR is maintained at a high level, showing that our approach is robust to network loss. Since TCP retransmits all the lost frames, the important frames are recovered in high error environment. The gaps in the sequence are due to selective packet drop in times of overflow of video buffer in proxy. Since we drop frames intelligently and transmit those important frames, error propagation is eliminated and the channel bandwidth is used to delivered high-quality video. The video is clearly of much higher quality and smoother than the UDP case, as frames are occasionally and strategically dropped.

We finally compare the delay of each frame with and without SPD at sender using TCP in FIG. 8. Without SPD, there is a cumulative delay which increases quickly. This is because TCP does retransmission in high error environment. As a result of a reduction of throughput, the video incoming rate is higher than delivery rate, leading to frame and hence delay accumulation in the buffer. On the other hand, when SPD is used, the delay time is kept to a low value. This is because frames are dropped to accommodate more recent frames and the delay time is bounded by the video buffer size in proxy.

According to a disclosed class of innovative embodiments, there is provided: A system for transmitting video data, comprising: a proxy server having a plurality of buffers, each buffer associated with an individual wireless client; a computer program-product on a computer readable medium configured to individually manager insertion and removal of video data into each buffer of the plurality; wherein if a buffer of the plurality fills, data is selectively dropped from that buffer.

According to a disclosed class of innovative embodiments, there is provided: A method for wireless communication of streaming video, comprising: routing a video stream to one or more proxy servers; communicating said video stream from said proxy server to one or more client clients; at a location local to said proxy server, tracking the bandwidth and/or processing capacity of said stations individually, and accordingly managing transmission to respective ones of said clients with individual optimization.

According to a disclosed class of innovative embodiments, there is provided: A network architecture for streaming video, comprising: a streaming server which encodes video into at least one stream of frames; plural clients; and at least one proxy server which receives said stream from said stream server and serves a subset of said clients, further comprising: buffers, ones of which are maintained to store said received frames for ones of said clients; and workers which independently manage said buffers, on a per client basis, to perform flow-based buffer management functions; whereby smooth video quality is achieved at said clients.

According to a disclosed class of innovative embodiments, there is provided: A method for transmitting streaming video across a network to a wireless client, comprising the steps of: receiving video data at a proxy server associated with a plurality of wireless clients; at the proxy, allocating buffer space associated with a client of the plurality; independently managing the insertion and removal of video data from the buffer to thereby optimize reception of video data at the client.

Modifications and Variations

As will be recognized by those skilled in the art, the innovative concepts described in the present application can be modified and varied over a tremendous range of applications, and accordingly the scope of patented subject matter is not limited by any of the specific exemplary teachings given.

For example, though TCP and UDP are given as example protocols, other protocols can be used.

For another example, though a proxy server is described, it is noted that the functions described herein can occur at other locations, such as at the encoder or streaming video server, for example.

For another example, though specific video frame formats are given in the examples listed herein, those formats are not intended to limit the possible formats that could be used. Other video formats can be implemented with the present innovations.

For another example, though a specific selective packet drop algorithm has been given in the examples, other algorithms could be implemented for managing the buffers consistent with the present innovations.

Additional general background, which helps to show variations and implementations, may be found in the following publications, all of which are hereby incorporated by reference:
[1] D. Wu, Y. Hou W. Zhu, Y. -Q. Zhang, and J. Peha “Streaming video over the internet: approaches and directions,” IEEE Transactions on Circuits and Systems for Video Technology, vol. 11, pp. 282-300, Mar. 2001.
[2] D. Wu, Y. Hou and Y. -Q. Zhang, “Scalable video coding and transport over broadband wireless networks,” in Proceedings of IEEE, vol. 89, Jan. 2001, pp. 6-20.
[3] T. -W. Lee, S. -H. Chan, Q. Zhang, W. -W. Zhu, , and Y. -Q. Zhang, “Allocation of layer bandwidth and FEC for video multicast over wired and wireless networks,” IEEE Transactions on Circuits and Systems for Video Technology, vol. 12, pp. 1059-1070, Dec. 2002.
[4] A. Majunda, D. Sachs, I. Kozintsev, K. Ramchandran, and M. Yeung, “Multicast and unicast real-time video streaming over wireless LANs,” IEEE Transactions on Circuits and Systems for Video Technology, vol 12, pp. 524-534, Jun. 2002.
[5] B. Girod and N. Farber, “Feedback-based error control for mobile video transmissions,” in Proceedings of the IEEE, vol. 87, Oct. 1999, pp. 1707-1723.
[6] S. Jan and W. Liao, “Supporting non-adaptable multimedia flows by a TCP-friendly transport protocol,” in IEEE Inter-national Conference on Multimedia and Expo, vol. 3, Jun. 2004, pp. 2091-2094.
[7] Q. Wang, K. Long, S. Cheng, and R. Zhang, “TCP-friendly congestion control schemes in the Internet,” in 2001 International Conferences on Info-tech and Info-net, vol. 2, Oct. 2001, pp. 221-216.
[8] B. Mukherjee and T. Brecht “Time-lined TCP for the TCP-friendly delivery of streaming media,” in International Conference on Network Protocols, Nov. 2000, pp. 165-176.
[9] A. R. Reibman, H. Jafarkhani, Y. Wang, and M. T. O. R. Puri, “Multiple-description video coding using motion-compensated temporal prediction,” IEEE Transactions on Circuits and Systems for Video Technology, vol. 12, pp. 193-204, Mar. 2002.
[10] A. Sehgal A. Jagmohan and N. Ahuja “Wireless video conferencing using multiple description coding,” in The 2001 IEEE International Symposium on Circuits and Systems, vol. 5, May 2001, pp. 303-306.
[11] L. A. Rowe and B. C. Smith, “A continuous media player,” in Proceedings of the Third International Workshop on Network and Operating System Support for Digital Audio and Video, Aug. 1992, pp. 376-386.
[12] A. Goel M. Shor J. Walpole D. Steere and C. Pu “Using feedback control for a network and CPU resource management application,” in Proceedings of the 2001 American Control Conference (ACC), vol. 4, Jun. 2001, pp. 2974-2980.
[13] S. Cen, C. Pu, R. Staehli, C. Cowan, and J. Walpole, “A distributed real-time mpeg video audio player,” in Proceedings of the 5th International Workshop on Network and Operating System Support for Digital Audio and Video, Apr. 1995, pp. 151-162.
[14] K. -W. Cheuk, S. -H. Chan, K. -W. Mong, C. -M. Lee, and S. -S. Sy, “Developing PDA for low-bitrate low-delay video delivery,” in Proceedings of IEEE International Conference on Mobile and Wireless Communications Networks, Oct. 2003.
[15] http://www.itu.int/ITU T/index.html.
[16] http://www.peoples.com.hk/.

None of the description in the present application should be read as implying that any particular element, step, or function is an essential element which must be included in the claim scope: THE SCOPE OF PATENTED SUBJECT MATTER IF DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A system for transmitting video data, comprising:
a proxy server having a plurality of buffers, each buffer associated with an individual wireless client;
a computer program-product on a computer readable medium configured to individually manage insertion and removal of video data into each buffer of the plurality;
wherein if a buffer of the plurality fills, data is selectively dropped from that buffer.

2. The system of claim 1, wherein communication between the proxy and a client uses TCP.

3. The system of claim 1, wherein communication between the proxy and a client uses UDP.

4. The system of claim 1, wherein the insertion and removal of video data is determined by a selective packet drop algorithm.

5. The system of claim 1, wherein the client decodes the video data.

7. The system of claim 1, wherein some buffers of the plurality are of different size.

7. The system of claim 1, wherein buffer size is dynamic.

8. A method for wireless communication of streaming video, comprising:
routing a video stream to one or more proxy servers;
communicating said video stream from said proxy server to one or more client clients;
at a location local to said proxy server, tracking the bandwidth and/or processing capacity of said stations individually, and accordingly managing transmission to respective ones of said clients with individual optimization.

9. The method of claim 8, wherein communication between the proxy and a client uses TCP.

10. The method of claim 8, wherein communication between the proxy and a client uses UDP.

11. The method of claim 8, wherein the clients are wireless clients.

12. The method of claim 8, wherein some video data sent to the proxy server is selectively dropped with respect to some clients according to a selective packet drop algorithm.

13. The method of claim 8, wherein the proxy server includes buffers associated with individual clients.

14. A network architecture for streaming video, comprising:
a streaming server which encodes video into at least one stream of frames;
plural clients; and
at least one proxy server which receives said stream from said stream server and serves a subset of said clients, further comprising:
buffers, ones of which are maintained to store said received frames for ones of said clients; and
workers which independently manage said buffers, on a per client basis, to perform flow-based buffer management functions;
whereby smooth video quality is achieved at said clients.

15. The architecture of claim 14, wherein management of said buffers is in dependence of said client's traffic conditions and types of frames.

16. This architecture of claim 14, wherein communication between a proxy server and client uses TCP.

17. The architecture of claim 14, wherein the communication between a proxy server and a client uses UDP.

18. The architecture of claim 14, wherein said workers manage said buffers using a selective packet drop algorithm.

19. The architecture of claim 14, wherein some ones of said buffers are of different size.

20. A method for transmitting streaming video across a network to a wireless client, comprising the steps of:
receiving video data at a proxy server associated with a plurality of wireless clients;
at the proxy, allocating buffer space associated with a client of the plurality;
independently managing the insertion and removal of video data from the buffer to thereby optimize reception of video data at the client.

21. The method of claim 20, wherein communication between the proxy and a client uses TCP.

22. The method of claim 20, wherein communication between the proxy and a client uses UDP.

23. The method of claim 20, wherein the proxy includes a plurality of buffers, and wherein individual ones of said buffers is associated with individual ones of said wireless clients.

24. The method of claim 20, wherein the buffers are managed using a multi-worker model which implements a selective packet drop algorithm.

25. The method of claim 20, wherein some of the buffers are of different size.
